(19) United States
(12) Patent Application Publication
(10) Pub. No.: US 2010/0166934 A1
(43) Pub. Date: Jul. 1, 2010

(54) EDIBLE INKS

(75) Inventors: Nigel Anthony Caiger, Wookey Hole (GB); Andrew Robin Balch, Southdown (GB); Sophia Rebecca Williams, Pentyrch (GB)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: SUN CHEMICAL CORPORATION, Parsippany, NJ (US)

(21) Appl. No.: 12/300,711

(22) PCT Filed: May 14, 2007
(86) PCT No.: PCT/US2007/011514

§ 371 Date: Sep. 16, 2009

(30) Foreign Application Priority Data
May 15, 2006 (GB) 0609603.6

(51) Int. Cl. A23L 1/09; A23L 1/275

(52) U.S. Cl. 426/572; 426/383

(57) ABSTRACT

An ink comprises a high-boiling gylcol and an edible colorant with optional further ingredients. The ink is an edible ink that is preferably suitable for application to substrates, especially food products, using ink-jet printing.

### TECHNICAL FIELD

The invention relates to edible ink compositions, their manufacture and use. In particular, the present invention relates to inks for use on food products.

### BACKGROUND ART

It is known to use inks to apply information to, or to decorate, food products. In recent times, as ink-jet printing has become widely used for many printing applications, that method of printing has been applied to a number of food products, for example, for the printing of information such as “use by” dates on products such as eggs, or for applying decorative material.

In one known method for decorating cakes, biscuits or the like, a pattern or image is printed onto an edible sheet of material using an ink-jet printer and that sheet is placed upon an edible product, especially a cake, biscuit or the like, as a result of which the pattern or image is incorporated into a surface of the edible product. In another known process, a pattern or image is printed using an ink-jet printer onto a laminate film material which carries an edible layer onto which the edible ink is printed and a backing layer which is removable from the edible layer. The printed sheet can then be used as a transfer, the backing being removed so that the edible layer can be adhered to an edible substrate. Those methods are time-consuming and usually require considerable manual input.

There have also been developed inks which can be printed, using an ink-jet printer, directly onto a surface of a food substrate. US 2005/0003055 and WO2005/122784 describe an edible printing fluid which can be applied to a substrate, such as cookies, crackers, breads or marshmallows, using ink-jet printing, the fluid comprising a propanediol, a food grade dye, and optionally water and/or glycerine. US2005/0255205 describes an edible printing fluid comprising propanediol and a food grade dye, additionally with a lower alcohol and a resin, for example, shellac, for printing on a variety of food products, including cereal products, biscuits, snacks and bread products. Where the fluids are applied to a substrate at elevated temperature, for example, 70° C., however, their viscosity is often below the optimum viscosity range for effective ink jet printing.

### DISCLOSURE OF INVENTION

The invention provides an edible ink comprising at least one edible glycol having a boiling point of not less than 200° C. and an edible colorant.

It is a particular advantage of the inks of the invention that they are of an optimum viscosity for ink-jet printing at elevated jetting temperatures, for example, at a temperature in the range of from 60 to 130° C., for example, at about 70° C. When ink-jet printed at temperatures at or above 70° C. the ink will during printing be heated to a temperature at which organisms in the ink may be destroyed, so that printing at such temperatures is advantageous. The inks of the invention are preferably used as ink jet inks for printing at temperatures of 60° C. or above.

“Boiling point” as used herein means boiling point at atmospheric pressure (101325 Pa).

It will be appreciated that the glycol or glycols used must be suitable for use in food products. The glycol 1,3-butylene glycol (which has a boiling point of 207° C.) and polyethylene glycols (hereafter “PEGs”) of mean molecular weight 200 to 9,500 are approved for use as additives by the US Food and Drug Administration, and are illustrative of glycols that may be used in the ink of the invention. Thus, in certain embodiments, the glycol may comprise 1,3-butylene glycol and/or one or more PEGs of mean molecular weight 200 to 9,500. PEGs having a variety of mean molecular weights in the range of 200 to 9,500 are commercially available from many sources and are widely used in food products. PEG 200 has a boiling point of about 250° C., whilst PEGs with higher molecular weights boil at higher temperatures.

In one preferred embodiment of the invention, the ink further comprises not more than 10% by weight based on the total weight of the ink, of ingredients of the ink having a boiling point of less than 200° C. It is especially preferred for not more than 5% by weight, based on the total weight of the ink, of ingredients of the ink to have a boiling point of less than 200° C. The ink preferably has a viscosity of from 8 to 20 mPa·s at a temperature in the range of from 60 to 130° C. Preferably the ink has a viscosity of from 8 to 20 mPa·s at 70° C. More preferably, the ink has a viscosity of from 9 to 16 mPa·s, especially from 10 to 14 mPa·s, at a temperature in the range of from 70° C. to 125° C. In one preferred embodiment, the ink has a viscosity of from 9 to 16 mPa·s at 70° C.

Colorants for use in the inks of the invention are edible colorants. The colorant is preferably present in an amount of from 0.1 to 15% by weight, for example 0.5 to 4% by weight, especially 1 to 4% by weight, based on the total weight of the ink. The selection of suitable colorants, having regard to the ink in question, will be a routine matter for those skilled in the art. In the case of inks which are fluid inks at 25° C., there may be used pigments, dyes or lakes. Dyes may be selected from synthetic dyes, natural dyes, and mixtures thereof. A wide variety of synthetic and natural dyes suitable for food use are known and commercially available. Lakes (also known as “lake pigments”) are pigments made by absorbing a dye onto an insoluble substrate. They are widely known for use in food products, and are in particular used in applications where it is desired to avoid smearing on exposure to humidity. They exhibit colour by reflection of light off the surface of the lake pigment.

In hot melt inks according to the invention, there are generally used pigments or lakes.

In selecting suitable colorants, the person skilled in the art will also have due regard to the need for the ink to be suitable for ink jet printing, and in particular the need to avoid colorants which comprise particulate material or corrosive components that are such as to render their use in ink jet printing apparatus undesirable.

The ink may contain up to 97% by weight, based on the total weight of the ink, of said at least one glycol with a boiling point of not less than 200° C. The ink may, for example, consist essentially of 97% by weight of a glycol or glycol mixture in which the or each glycol has a boiling point of at least 200° C. and said edible colorant.

In one preferred form, the ink of the invention is liquid at ambient temperature (hereafter referred to as a “fluid ink”). The glycol or glycol mixture in said fluid ink is advantageously selected from 1,3-butylene glycol, PEGs with a molecular weight in the range of 200 to 500, and mixtures thereof.

The fluid ink may optionally further include one or more additional ingredients selected from surfactants, viscosity modifiers, solvating agents, preservatives, and carriers. Selection of the identity and amounts of such additional ingredients would be a routine matter within the skill and expertise of those skilled in the art, and is naturally to be practised such that any additional ingredients do not materially or unacceptably interfere with the desired characteristics of the ink, for example, its suitability for use in food products.

In the fluid inks of the invention, the edible colorant is preferably a dye. Where a dye is used, it will often be expedient to include additionally a co-solvent for the dye. An excellent co-solvent for many of the suitable dyes is glycerol which is itself suitable for use in an edible ink. Where present, the ink comprises glycerol in an amount not exceeding 20% by weight, based on the total weight of the ink. Preferably, glycerol is present in an amount of from 5 to 15% by weight.

In certain of the fluid inks according to the invention, there may be present in the fluid one or more additional carriers of lower viscosity than the glycol or glycol mixture. A preferred additional carrier is triacetin, which is a low viscosity liquid of high boiling point and which is suitable for food use. The amount of the additional carrier, for example triacetin, may be varied in order to influence in a desired manner the viscosity of the ink. Use of one or more additional carriers may in particular be expedient where higher PEGs of molecular weight in excess of 300 are used, with the additional carriers then generally being selected to have low viscosity relative to the higher PEG.

As suitable surfactants for modifying the surface tension of the ink there may be used any surfactant that is suitable for food use, for example, sorbitan esters such as polysorbate 80; fatty acids; fatty acid esters such as polyglycerol esters of fatty acids; lecithins. Where present the amount of surfactant is preferably less than 5% by weight, more preferably less than 2% by weight, for example 0.1 to 1.0% by weight, based on the total weight of the ink.

Optionally there may further be included one or more preservative, for example, methylparaben or propylparaben, or mixtures thereof.

In one preferred embodiment, a fluid ink according to the invention comprises from 50 to 98%, for example 60 to 90%, glycol, from 0.1 to 4% colorant, and optionally up to 30% additional carrier and/or up to 20% co-solvent (especially glycerol), as well as, optionally, up to 5% surfactant and/or up to 1% preservative, wherein in each case % is by weight based on the total weight of the resultant ink.

In a second preferred form, the ink of the invention is a hot melt ink, which is solid or semi-solid at 25° C. whilst having a viscosity that is suitable for ink-jet printing at a temperature of greater than 50° C. Advantageously, the hot melt ink has a viscosity of from 8 to 20 mPa·s at a temperature in the range of from 60 to 130° C., preferably from 70° C. to 125° C. Most preferably, the ink has a viscosity of from 9 to 16 mPa·s, especially from 10 to 14 mPa·s, at a temperature in the range of from 70° C. to 125° C.

In one preferred hot melt ink according to the invention, the viscosity is from 9 to 16 mPa·s at 70° C.

In the hot melt inks of the invention, the glycol or glycol mixture is preferably made up of one or more PEGS each having a molecular weight of 800 or more, for example of 1000. The hot melt ink advantageously includes from 75 to 99% glycol, preferably 90 to 98% glycol, based on the total weight of the ink. The hot melt ink preferably comprises one or more PEGs in combination with an edible lake. Advantageously the hot melt inks consist essentially of one or more PEGs and an edible colorant, for example, of at least 90% of one or more PEGs and up to 10%, for example, from 0.1 to 8%, preferably 0.5 to 5%, colorant, especially lake.

The hot melt inks of the invention may optionally further include one or more additional ingredients selected from antioxidants, surfactants, and resins (such as shellac, rosin esters and modified rosin esters). The total amount of such further ingredients, where present, is preferably not more than 20%, more preferably not more than 15%, especially not more than 10%, and in some cases not more than 2%, by weight based on the total weight of the ink. Selection of the identity and amounts of such additional ingredients would be a routine matter within the skill and expertise of those skilled in the art of hot melt inks, and is naturally to be practised such that any additional ingredients do not materially or unacceptably interfere with the desired characteristics of the ink, for example, its suitability for use in food products. By way of example, individually or in combination, surfactant may be present in an amount of up to 1%, for example, from 0.1 to 0.75%, antioxidant may be present in an amount of 0.1 to 1%, and resins may be present in amounts of up to 15%, for example from 1 to 10%, in each case by weight based on the total weight of the ink.

It will be appreciated that components of the inks of the invention must be selected having regard to the need for the ink to be edible. Thus, edible materials should be used. The term “edible” is used herein with reference to inks and to any individual ingredient thereof to mean that the ink or ingredient is suitable for ingestion by a human without normally causing any detrimental health effects. Many substances are identified in data published by government regulatory authorities as being suitable for use in food for human consumption. Ingredients and additives that are authorised for food use in the US Food and Drug Administration (FDA), US Code of Federal Regulations, Title 21, Food and Drugs, revised Apr. 1, 2003, are in particular to be understood as being edible in the sense in which that term is used herein. It will of course be appreciated that such ingredients must moreover be of a quality or purity suitable for food use. For the avoidance of doubt, “edible” as used herein further extends to any ingredient or additive that, whilst not being listed in any such list as amended from time to time, can normally be ingested by a human without detrimental effect on health. “Food grade” is used herein to refer to ingredients that are of a nature and quality suitable for use in food products, including in particular those identified in the above-mentioned FDA Regulations.

The inks of the invention are suitable for use as ink-jet inks for printing onto substrates, especially food substrates. Fluid inks of the invention containing dyes are suitable for ink-jet printing on a variety of food products, especially porous products, including but not limited to biscuits, dry-iced products, high fat icing, and snack products. The fluid inks containing pigment, for example, lakes, are suitable for printing on, for example, chewing gum, high moisture icing and other high moisture porous foods. Hot melt inks of the invention are suitable for ink-jet printing on, especially, products with high moisture contents, such as chilled foods and frozen foods, and including ice cream cakes, yoghurts, cakes and chocolate.

### MODES FOR CARRYING OUT THE INVENTION

The Examples below illustrate the invention. Viscosity values throughout the specification are, unless otherwise specified, at 25° C. Viscosity measurements in the Examples were made using a Brookfield DV-1+ Viscometer using a spindle no. 18, at a shear rate of 100 rpm. The sample was heated by means of a water-heated sample jacket. In the Examples and throughout the specification “%” means % by weight based on all ingredients unless otherwise stated.

Surface tension values mentioned herein are, unless otherwise specified, at 25° C., and as measured by Du Nuoy ring method.

### Example 1

### Fluid Ink-Jet Ink

| | Amount (% by |
|---|---|
| Ingredients | weight) |
| Polyethylene glycol 200 | 65.95 |
| molecular weight | |
| Triacetin | 20.00 |
| Glycerol | 10.00 |
| *FD&C Blue No. 1 | 3.50 |
| Polysorbate 80 | 0.50 |
| Methylparaben | 0.05 |

*A commercial powdered dye available from Sensient Colors, Inc., St Louis, Missouri, USA

The polyethylene glycol, triacetin, glycerol, polysorbate and methylparaben were mixed together for approximately five minutes. The dye was added whilst mixing was continued, with mixing being continued for a further thirty minutes. The resulting fluid was filtered with a 1 μm filter.

The resultant ink had a viscosity of 11.2 mPa·s at 70° C. The viscosity at 25° C. was 91 mPa·s. The ink had a surface tension of 38 dynes/cm (0.035 to 0.040 N/m) at 25° C. It was ink-jet printed from a Spectra Nova 256 AAA printhead using a printhead at 8 and 12 kHz frequency and 100% duty cycle, at a temperature of 70° C. A maximum of one jet was lost in five minutes of continuous printing. That represents an excellent maintenance of printing quality, which enables continuous printing in practice to be continued at high production speed to an acceptable print quality for substantial periods, for example, up to a number of hours, without interruption for maintenance of the printhead. The ink also gives negligible deterioration in the printhead during interruption, permitting trouble-free restart of printing after a longer interruption, for example, overnight.

### Comparative Example A

| | Amount (% by |
|---|---|
| Ingredients | weight) |
| Glycerol | 81.5 |
| Water | 15.00 |
| *FD&C Blue No. 1 | 3.00 |
| Polysorbate 80 | 0.50 |

The ink was made using the method described in Example 1. The resultant ink had a viscosity of 10.3 mPa·s at 70° C. a viscosity of 88 mPa·s at 25° C. and a surface tension of 0.037 N/m at 25° C. When printed under the jetting conditions defined in Example 1, the ink would not print above 4 kHz without losing multiple jets, indicating poor reliability.

### Example 2

### Hot Melt Ink-Jet Ink

| | Amount (% by |
|---|---|
| Ingredients | weight) |
| PEG 1000 | 90.45 |
| PEG 200 | 6 |
| *FD&C Blue No. 1 Lake | 3 |
| Polysorbate 80 | 0.5 |
| Methylparaben | 0.05 |

The FD&C lake was mixed with PEG 200 by high shear Silverson mixer and then passed through a Dispermat bead mill until the particle size was submicron. This concentrate was then mixed, with high shear stirring, into the molten PEG 1000 by stirring the sample whilst on a hot plate held at 100° C. The other ingredients were added and the total ink mixed for 20 minutes. The ink was solid at room temperature, and was ink-jet printed at 125° C. The viscosity of the ink at 125° C. was 12.2 mPa·s.

Although the foregoing invention has been described in detail by way of example for purposes of clarity of understanding, it will be obvious that changes and modifications may be practised within the scope of the appended claims.

1. An edible ink comprising at least one edible glycol having a boiling point of not less than 200° C. and an edible colorant.

2. An ink according to claim 1, in which the or each edible glycol having a boiling point of not less than 200° C. is selected from 1,3-butylene glycol and polyethylene glycols having a molecular weight in the range of 200 to 9,500.

3. An ink according to claim 1, wherein the ink further comprises not more than 10% by weight, based on the total weight of the ink, of ingredients having a boiling point of less than 200° C.

4. An ink according to claim 1, wherein the ink further comprises not more than 5% by weight, based on the total weight of the ink, of ingredients having a boiling point of less than 200° C.

5. An ink according to claim 4, which contains up to 97% by weight, based on the total weight of the ink, of said at least one glycol with a boiling point of not less than 200° C.

6. An ink according to claim 1, which consists essentially of a glycol and said edible colorant.

7. An ink according claim 1, in which said at least one glycol comprises a mixture of glycols in which said glycol mixture the or each glycol in said mixture has a boiling point of at least 200° C.

8. An ink according to claim 7, which consists essentially of said glycol mixture and said edible colorant.

9. An ink according to claim 1, wherein said colorant is present in an amount of from 0.1 to 15% by weight, based on the total weight of the ink.

10. An ink according to claim 1, wherein the viscosity is from 8 to 20 mPa·s at a temperature in the range of from 60 to 130° C.

11. An ink according to claim 8, wherein the ink has a viscosity of from 9 to 16 mPa·s at a temperature in the range of from 70° C. to 125° C.

12. An ink according to claim 1, which is liquid at 25° C.

13. An ink according to claim 12, in which the glycol or glycol mixture is selected from 1,3-butylene glycol, PEGs with a molecular weight in the range of 200 to 500, and mixtures thereof.

14. An ink according to claim 12, in which the edible colorant is an edible dye.

15. An ink according to claim 14, further comprising a co-solvent for the dye.

16. An ink according to claim 15, in which the co-solvent is glycerol.

17. An ink according to claim 16, comprising glycerol in an amount not exceeding 20% by weight, based on the total weight of the ink.

18. An ink according to claim 1, further comprising a carrier of lower viscosity than the glycol or glycol mixture.

19. An ink according to claim 1, which is solid or semi-solid at 25° C. whilst having a viscosity that is suitable for ink jet printing at a temperature of greater than 50° C.

20. An ink according to claim 19, in which the glycol or glycol mixture is made up of one or more PEGs each having a molecular weight of 800 or more.

21. An ink according to claim 19, which further comprises a PEG of molecular weight less than 800 in an amount of up to 10% of the total PEG content.

22. An ink according to claim 21, in which the glycol or glycol mixture is made up of one or more PEGs each having a molecular weight of 800 or more.

23. An ink according to claim 22, in which the glycol or glycol mixture consists essentially of PEG 1000.

24. An ink according to claim 19, which consists essentially of one or more PEGs in combination with said edible colorant.

25. An ink according to claim 19, in which the colorant is a lake.

26. An ink according to claim 1, which is suitable for printing using an ink-jet printing process.

27. An ink-jet ink comprising: a glycol component having a boiling point of not less than 200° C. and comprising a food grade glycol or a mixture of food grade glycols; and a food grade colorant.

28. A method of printing onto a food substrate, comprising ink-jet printing onto said substrate an ink according to claim 1, the ink-jet printing being carried out at a temperature of from 60 to 140° C.
